(19) United States
(12) Patent Application Publication
(10) Pub. No.: US 2008/0127694 A1
(43) Pub. Date: Jun. 5, 2008

(54) Pin Tumbler Lock

(76) Inventors: Cheuk Hang Wong, Hong Kong (HK); Tak Shing Lau, Hong Kong (HK); Tak Kin Lau, Hong Kong (HK)

Correspondence Address: VEDDER PRICE KAUFMAN & KAMMHOLZ, 222 N. LASALLE STREET, CHICAGO, IL, 60601, US

(21) Appl. No.: 11/925,369

(22) Filed: Oct. 26, 2007

(30) Foreign Application Priority Data
Dec. 1, 2006 (HK) 06113261.9

(51) Int. Cl. E05B 27/04

(52) U.S. Cl. 70/493

(57) ABSTRACT

A pin tumbler lock, operating between a locked position and a released position, comprising a first lock member having at least one first bore with a biasing device and a first pin deposing in the first bore, and a second lock member engaging with the first lock member, forming an interface surface with said first lock member. The second lock member has at least one second bore with a second pin disposed in the second bore, and is aligned with the first bore for receiving the first pin in the locked position. At least one pin is magnetized, and the corresponding second pin is magnetic permeable, such that, when the pins are mobilized by an external force, the magnetized pin remains attracted to the corresponding magnetic permeable pin. No open space between the pins is formed at the interface surface to release the lock members.

### CROSS REFERENCE TO RELATED APPLICATIONS

The present patent application claims priority from and the benefit of Hong Kong Patent Application No. 06113261.9, filed Dec. 1, 2006, and entitled PIN TUMBLER LOCK, which prior application is hereby incorporated herein by reference.

### FIELD OF THE INVENTION

The present invention relates to a pin tumbler lock.

### BACKGROUND OF THE INVENTION

A pin tumbler lock is a type of lock commonly used, for example, in doors of houses. A pin tumbler lock includes a housing shell and a plug forming an interface surface. The shell and the plug each contain a number of radial bores corresponding with those in each other. Each bore in the shell contains a first pin and each bore in the plug contains a second pin. In the locked position, a biasing device in each of the bore pushes the first pin against the second pin, such that a pin in each bore is positioned across the interface surface between the plug and the shell to bolt the lock. When the correct key is inserted into the keyhole on the plug, the second pins inside the bores of the plug will be pushed outwardly against the corresponding first pins in the shell, such that the contact surfaces between all the first and the corresponding second pins align with the interface surface between the plug and the shell. In such position, the pins do not bolt the lock and the key can rotate the plug to open the lock. If the key does not match with the plug, some or all the first or the second pins will be positioned cross the interface surface between the plug and the shell to bolt the lock. Accordingly, the key cannot then turn the plug to open the lock.

Pin tumbler locks are popularly used, and there emerges various methods of opening a pin tumbler lock without a mating key, for example, by using a bump key. This method requires the use of a special key, on which all the depressions on the shank of the key are grinded to a certain depth, such that when the key is inserted into the keyhole, all the second pins remain in the bore of the plug. At this position, all the second pins are in contact with the corresponding first pins. When the bump key is hit by a tool on the key head, the momentum is transmitted from the second pin to the first pin in contact, causing a momentary separation between all the first and the second pins. If all the first and the second pins are separated at the same time, and all the open spaces between the first and the second pins so formed are aligned with the interface surface between the shell and the plug, the key can turn the plug to open the lock.

There is no solution yet to prevent lock picking using bump key. This invention provides a pin tumbler lock that prohibits picking by bump key.

### SUMMARY OF THE INVENTION

It is an objective of the present invention to provide an improved pin tumbler lock that prohibits picking by using bump keys.

The pin tumbler lock of the present invention, operating between a locked position and a released position, comprises a first lock member and a second lock member. The first lock member has at least one first bore with a biasing device and a first pin deposing in the first bore. The second lock member engages with the first lock member, and forms an interface surface with the first lock member. The second lock member has at least one second bore with a second pin disposed in the second bore.

In the locked position, the first bore is aligned with the corresponding second bore, and the first pin forms a contact surface with the second pin. The first pin is forced into the second bore by the biasing device and deposes across the interface surface to lock the first and second lock members. In the released position, the first pin is forced by the second pin to a position where the contact surface is aligned with the interface surface.

At least one of the external and internal pins is magnetized, and the other corresponding pin is magnetic permeable.

When the pins are mobilized by a bump key, the magnetized pins remain attracted to the corresponding magnetic permeable pin such that no open space between the first and the second pins is formed at the interface surface between the lock members to release the lock. The lock therefore prevents against lock picking by using bump keys.

### BRIEF DESCRIPTION OF THE DRAWINGS

The above and other aspects, features, and advantages of the present invention will become more apparent upon consideration of the following detailed description of preferred embodiments, taken in conjunction with the accompanying drawing figures, wherein:

FIG. 1 is a perspective internal view of the pin tumbler lock according to an embodiment of this invention;

FIGS. 2a and 2b are the perspective internal views illustrating the locked position and the released position of the pin tumbler lock of FIG. 1;

FIGS. 3a and 3b are the perspective internal views illustrating how the pin tumbler lock of FIG. 1 reacts to lock picking by a bump key;

FIGS. 4a and 4b are the perspective internal views of the pin tumbler lock according to another embodiment of the present invention.

### DESCRIPTION OF A PREFERRED EMBODIMENT OF THE INVENTION

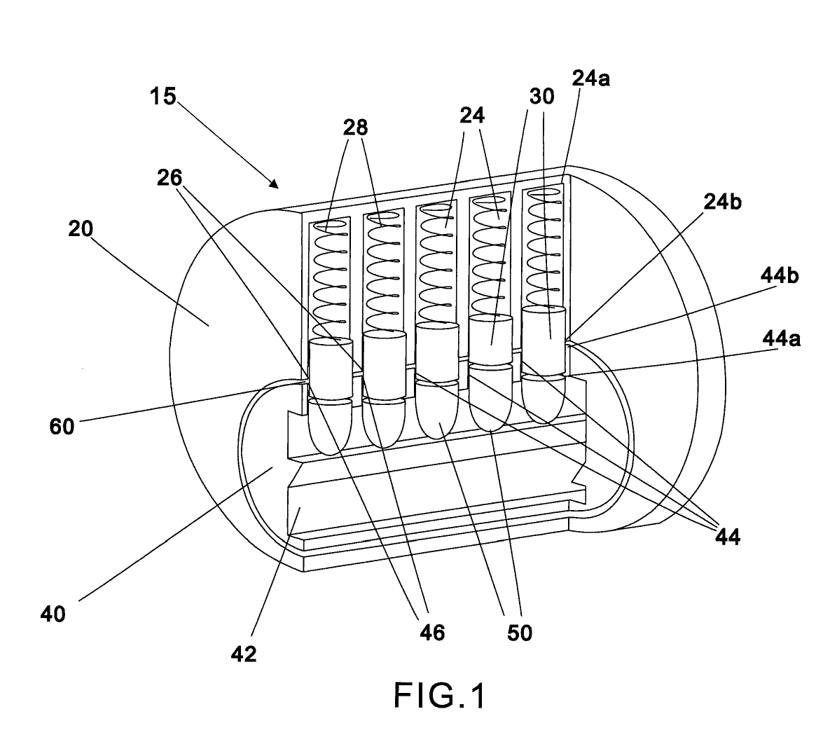

As shown in FIG. 1, a pin tumbler lock 15 includes a first lock member and a second lock member. The first lock member may be an annular shell 20. The shell 20 has at least one radial first bore 24. Each of the first bores 24 contains a first pin 30 of different sizes. A biasing device 28, for example, an ordinary spring, is disposed at the end 24a of the first bore 24 distal from the axis of the shell 20. The other end 24b of the bore 24 is an opening 26.

The second lock member may be a plug 40. In this embodiment, the plug 40 is cylindrical and is surrounded by shell 20. An interface surface 60 is formed between the shell 20 and the plug 40. There is a keyhole 42 on the plug 40 for the insertion of a key 10. The keyhole 42 is connected with at least one radial second bore 44 on the plug 40 at one end 44a of the second bore 44. The other end 44b of the second bore 44 is an opening 46, which corresponds to the opening 26 of the first bore 24. Each of the second bores 44 contains a second pin 50 of different sizes. In the locked position, the biasing device 28 releases and pushes the first pin 30 against the second pin 50, such that the first pin 30 is bolted across the interface surface 60 to lock the shell 20 and the plug 40.

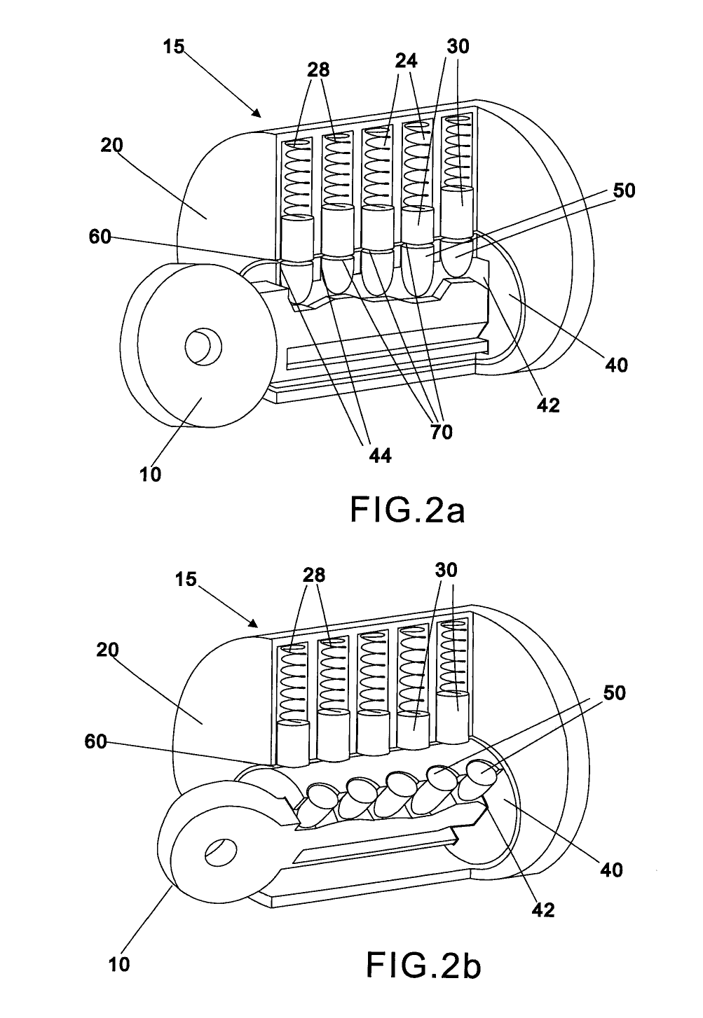

As shown in FIG. 2a and FIG. 2b, when the key 10 which mates with the plug 40 is inserted into the keyhole 42, the second pin 50 in each of the bore 44 will be pushed outwardly against the first pin 30 and against the biasing device 28. When the contact surface 70 between each of the second pin 50 and the first pin 30 is aligned with the interface surface 60, at this released position the key 10 can turn the plug 40 to open the pin tumbler lock 15.

In an embodiment of the invention, at least one of the first pin 30 and the second pin 50 is magnetized, while the other pin is magnetic permeable and is attracted to the magnetized pin by containing, for example, Iron, Nickel or Steel. When the second pin 50 is mobilized by an external force, the first pin 30 will remain attracted to the second pin 50, such that no open space between the first pin 30 and the second pin 50 can be formed at the interface surface 60. The magnetic force between the first pin 30 and the second pin 50 shall not be too large that the pin 30 and the pin 50 cannot be separated by the shear force exerted by the turning key 10 in the released position.

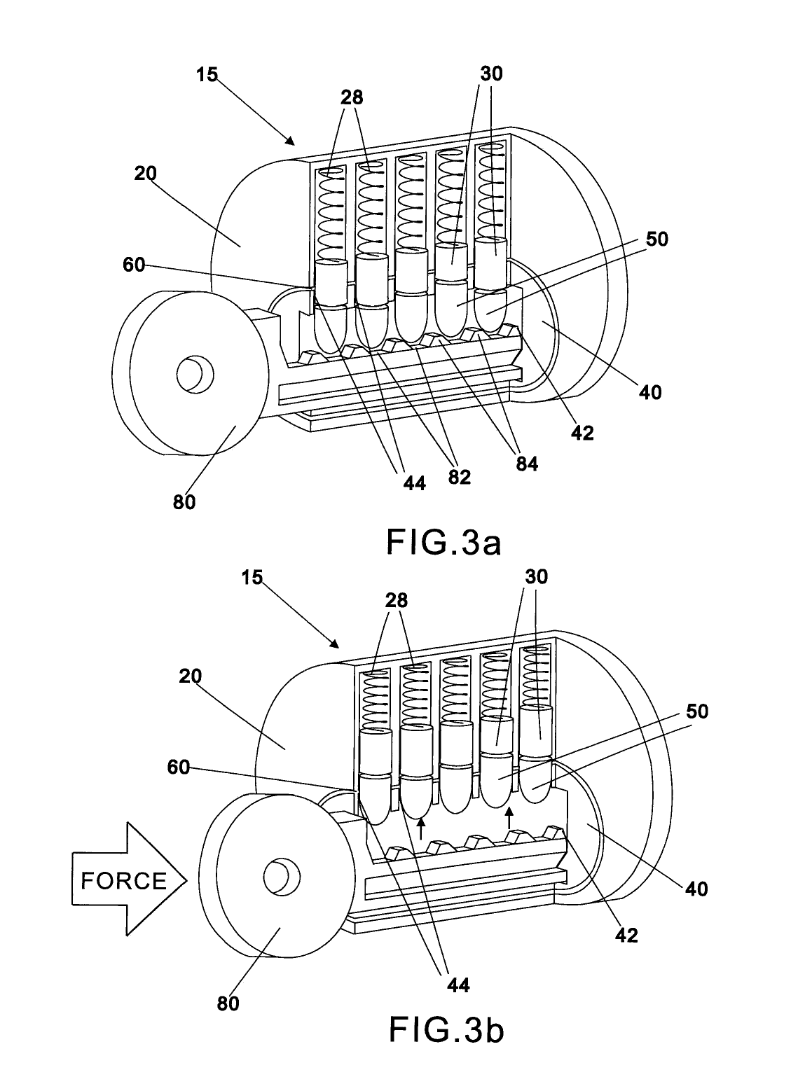

As shown in FIG. 3a and FIG. 3b, each of the depressions 82 on the bump key 80 is grinded to a certain depth such that when the bump key 80 is inserted into the keyhole 42, the whole second pin 50 remains in the second bore 44. In this position, the second pin 50 is in contact with the first pin 30. When an external force is applied on the bump key 80, for example, being hit by a tool on the key head, the momentum is transmitted from the second pin 50 to the first pin 30, and causes the first pin 30 to bounce up. But since the magnetic force constantly attracts the first pin 30 to the second pin 50, both the second pin 50 and the first pin 30 will be bounced together, preventing any momentary separation of the first pin 30 from the second pin 50, which forms an open space aligned with the interface surface 60 between the shell 20 and the plug 40. The shell 20 and the plug 40 remain being bolted by either the first pin 30 or the second pin 50. The pin tumbler lock 15 therefore cannot be open by the bump key 80.

The magnetized pin may contain magnetic substance, or may be attached with something of a magnetic nature in different shapes. The magnetized pin may also be a whole piece of magnetic substance. The magnetic substance is a substance which displays magnetic properties, for example, magnetic Iron, magnetic Nickel, magnetic Cobalt, magnetic Ferrite, magnet, lodestone or natural magnet. There can be different combinations of the first pin 30 and the second pin 50, for example, a magnetized first pin 30 with a magnetic permeable second pin 50, or a magnetic permeable first pin 30 with a magnetized second pin 50.

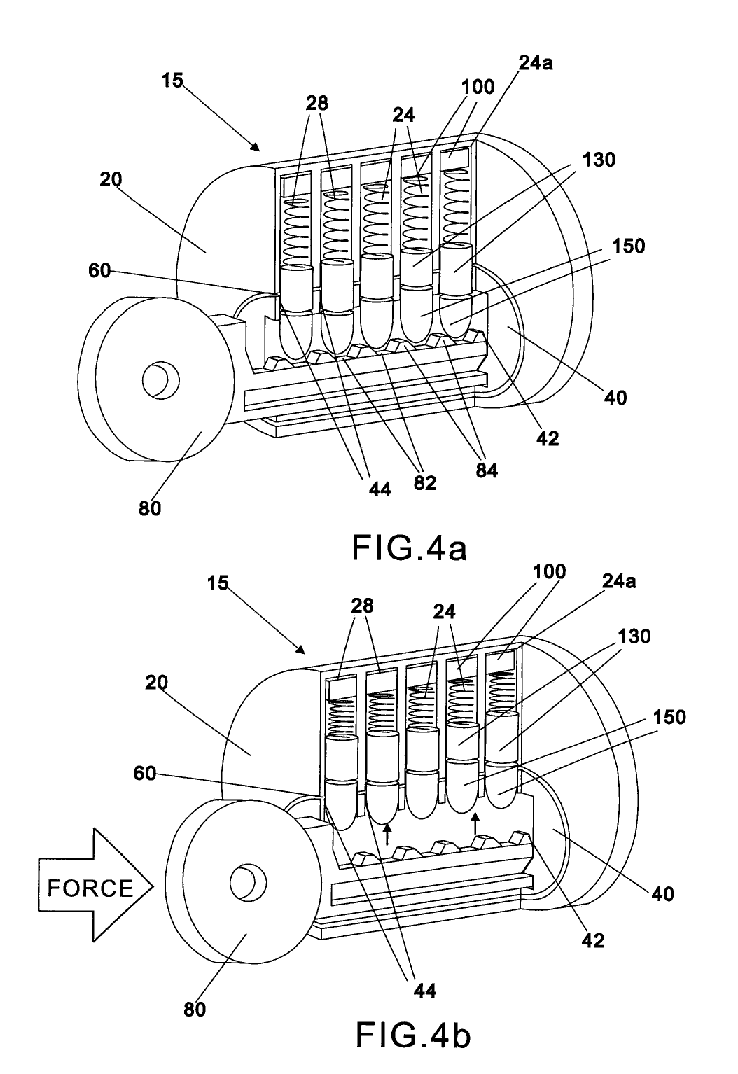

As shown in FIG. 4a and FIG. 4b, in another embodiment, a piece of magnetic substance, for example, a magnet 100, is disposed in the shell 20. The magnet 100, for example, may be disposed at the end 24a of the first bore 24 near the biasing device 28. The first pin 130 in the first bore 24 and the second pin 150 in the second bore 44 are both magnetic permeable pins. The magnet 100 magnetizes the first pin 130 and the second pin 150. When force is applied to a bump key to open the pin tumbler lock 15, the magnetized first pin 130 and the magnetized second pin 150 remain attracted to each other. The external force from the bump key will not cause any momentary separation of the first pin 130 from the second pin 150, and thus not form any open space aligned with the interface surface 60 between the shell 20 and the plug 40. The pin tumbler lock 15 therefore cannot be open by the bump key 80.

The magnetic force of the magnet 100 which attracts the second pin 150 and the first pin 130 shall be smaller than the releasing force of the biasing device 28, to avoid the pins from compressing against the biasing device 28 or being attached to the magnet 100. This magnetic force shall also not be too large that the first pin 130 and the second pin 150 can not be separated by the shear force exerted by the turning key 10 to open the pin tumbler lock 15 in the released position.

The embodiments described in this specification and the contents disclosed therein are provided by way of illustration only. The invention can be applied equally well on other types of pin tumbler lock.

While the invention has been described in detail with reference to disclosed embodiments, various modifications within the scope of the invention will be apparent to those of ordinary skill in this technological field. It is to be appreciated that features described with respect to one embodiment typically may be applied to other embodiments.

1. A pin tumbler lock, operating between a locked position and a released position, comprising:
a first lock member having at least one first bore with a biasing device and a first pin deposing in said first bore;
a second lock member engaging with said first lock member, forming an interface surface with said first lock member, said second lock member having at least one second bore with a second pin disposed in said second bore, said second bore being aligned with said first bore for receiving said first pin in the locked position;
at least one said pin is magnetized, said corresponding second pin is magnetic permeable,
wherein, when said pins are mobilized by an external force, said magnetized pin remains attracted to said corresponding magnetic permeable pin such that no open space between said first and second pins is formed at said interface surface to release said lock members.

2. The pin tumbler lock as recited in claim 1, wherein said first lock member comprises magnetic substance for magnetizing at least one said pins.

3. The pin tumbler lock as recited in claim 1, wherein said magnetized pin comprises magnetic substance.

4. The pin tumbler lock as recited in claim 2, wherein said magnetic substance is selected from a group comprising magnet, natural magnet, lodestone, magnetic iron, magnetic nickel, magnetic cobalt and magnetic ferrite.

5. The pin tumbler lock as recited in claim 3, wherein said magnetic substance is selected from a group comprising magnet, natural magnet, lodestone, magnetic iron, magnetic nickel, magnetic cobalt and magnetic ferrite.

6. A pin tumbler lock, operating between a locked position and a released position, comprising:
a shell having at least one radial first bore, with a biasing device and a first pin disposing in said first bore;
an axial plug being deposed in said shell, forming an interface surface with said shell, said plug having at least one radial second bore, with a second pin disposing in said second bore, said second bore being aligned with said first bore for receiving said first pin in the locked position;
at least one said pin is magnetized, said corresponding second pin is magnetic permeable,
wherein, when said pins are mobilized by an external force, said magnetized pin remains attracted to said corresponding magnetic permeable pin such that no open space between said first and second pins is formed at said interface surface to release said shell and plug.

7. The pin tumbler lock as recited in claim 6, wherein said shell comprises magnetic substance for magnetizing at least one said pins.

8. The pin tumbler lock as recited in claim 6, wherein said magnetized pin comprises magnetic substance.

9. The pin tumbler lock as recited in claim 7, wherein said magnetic substance is selected from a group comprising magnet, natural magnet, lodestone, magnetic iron, magnetic nickel, magnetic cobalt and magnetic ferrite.

10. The pin tumbler lock as recited in claim 8, wherein said magnetic substance is selected from a group comprising magnet, natural magnet, lodestone, magnetic iron, magnetic nickel, magnetic cobalt and magnetic ferrite.
